(19) United States
(12) Patent Application Publication
(10) Pub. No.: US 2026/0241456 A1
(43) Pub. Date: Aug. 20, 2026

(54) METHOD, SYSTEM AND PROGRAM FOR PRODUCING A REFINER SEGMENT OUT OF A WORN REFINER SEGMENT, AND A REBUILT REFINER SEGMENT

(71) Applicant: VALMET AB, Sundsvall (SE)

(72) Inventor: Christer HEDLUND, Katrineholm (SE)

(21) Appl. No.: 19/489,612

(22) PCT Filed: Jun. 27, 2024
(86) PCT No.: PCT/EP2024/068055

§ 371 Date: Dec. 3, 2025

(30) Foreign Application Priority Data
Aug. 21, 2023 (EP) 23192361.6

(51) Int. Cl. B22F 10/80; B22F 10/28; B22F 12/90; B33Y 10/00; B33Y 30/00; B33Y 40/10; B33Y 50/00; B33Y 80/00

(52) U.S. Cl. CPC B22F 10/80; B22F 10/28; B22F 12/90; B33Y 10/00; B33Y 30/00; B33Y 40/10; B33Y 50/00; B33Y 80/00; B22F 2998/10

(57) ABSTRACT

Provided is a method for producing a refiner segment for refining lignocellulosic material. The method is suitable for rebuilding a refiner segment out of a worn refiner segment. The method includes providing a refiner segment workpiece; supplying rebuilding production data of a refining portion to a control device of an additive manufacturing device; and 3D printing the refining portion on the refiner segment workpiece by using the rebuilding production data. The worn refiner segments represent a substantial value and by re-using the used refiner segments the expensive process of melting them down and casting them again can be avoided.

### BACKGROUND

### Technical Field

The present invention relates generally to the producing a refiner segment of a refiner intended for defibrating lignocellulosic material, and in particular to a method, system and program for rebuilding a refiner segment by using a worn refiner segment by additive manufacturing process, and a rebuilt refiner segment.

### Related Art

Refiners used for refining lignocellulosic material, e.g., wood chips, saw dust and other fibrous material from wood or plant, in manufacturing mechanical pulp typically comprise two or more refiner elements positioned oppositely and rotating relative to each other. The fixed, i.e. stationary, refiner element is called the stator of the refiner, the rotating or rotatable refiner element being called the rotor of the refiner. In disc refiners, the refiner elements are disc-like, and in cone refiners, the refiner elements are conical. In addition to disc refiners and cone refiners, there are also what are called disc-cone refiners, where disc-like refiner elements come first in the flow direction of the material to be defibrated, and after them the material to be defibrated is refined further between conical refiner elements. Furthermore, there are also cylindrical refiners, where both the stator and the rotor of the refiner are cylindrical refiner elements. For example, the refining surfaces of the disc refiners, which represent the most common refiner type, may be either surfaces formed directly on the disc refiners, or they may be formed as separate refiner segments positioned adjacent to each other in such a way that the refining surface of each refiner segment forms a part of a continuous refining surface. In order to defibrate and discharge the lignocellulosic material, the refining surfaces are formed by bars, grooves between bars and dams usually connecting two adjacent bars to each other.

A particular problem associated with refiner segments equipped with bars and dams is that the bars and dams, being structures protruding from the refining surfaces of the refiner segments, will be worn down, sometimes scrapped or chipped, due to the abrasive contact they have with the material to be refined during manufacturing mechanical pulp. Examples for refiner segments equipped with bars and dams can be known from patent literature SE 540890 C2. The efficiency of the refiner segment will as a consequence decrease over time and become a worn refiner segment (or used refiner segment) that can no longer achieve a satisfactory quality of the refined lignocellulosic material, e.g., mechanical pulp. Usually, said used refiner segments are still good except the worn down refining surfaces.

### BRIEF DESCRIPTION OF THE INVENTION

### Problems to be Solved

Most of the time, the used refiner segments may be just thrown away or used in waste utilization merely for recycling the material by melting. Therefore, there is a need for a technique to make the used refiner segments useable and as good as new refiner segments in order not wasting them.

The invention aims to provide techniques that the refining surfaces of the used refiner segments are rebuilt to have rebuilt refining surfaces that achieve a satisfactory quality of the refined lignocellulosic material, namely by using the used refiner segments to produce new refiner segments having useable refining surfaces in manufacturing mechanical pulp process.

### Means to Solve Problems

The above-mentioned object of the invention is to provide means for producing a refiner segment out of a worn refiner segment according to the independent claims. Preferred embodiments are set forth in the dependent claims. The description below refers to, by using a used refiner segment, a refiner segment is produced by additive manufacturing process, i.e., a 3D (three-dimensional) printing process. However, it should be understood that the present disclosure also discloses the corresponding methods of producing the refiner segments.

The basic idea in the present disclosure is using a 3D printing method to rebuild the refining portion (e.g., the worn portions, e.g. of bars and dams) by using a used refiner segment (for example a worn (used) refiner segment of a used disc-type refiner). This may be achieved by either directly rebuilding the refining portion on the used refiner segment by using 3D printing process, or performing a machining process to the worn portion of the used refiner segment before rebuilding the refining portion and then performing the rebuilding the refining portion by using 3D printing process.

Benefits of the present invention lie in: making the worn refiner segments represent a substantial value; by re-using the used refiner segments avoiding the expensive process of melting them down and casting them again; making the greatest advantages of existing data files of 3D printable models of the refiner segments; by using 3D printing method to rebuild the refining portions significantly increasing the variety of shapes and arrangements of surface structures (the pattern of bars and dams) of the refining portions since 3D printing method does not have such limitations such that new structures may be implemented and tested with moderate expenses.

According to an aspect of the present invention, there is provided a method for producing a refiner segment for refining lignocellulosic material. The method is suitable for rebuilding a refiner segment out of a worn refiner segment. The method comprises providing a refiner segment workpiece; supplying rebuilding production data of a refining portion to a control device of an additive manufacturing device; and 3D printing the refining portion on the refiner segment workpiece by using the rebuilding production data.

According to another aspect of the present invention, there is provided a system for producing a refiner segment for refining lignocellulosic material. The system is suitable for rebuilding a refiner segment out of a worn refiner segment, the system comprising: a stage, configured that a refiner segment workpiece is arranged thereon; and an additive manufacturing device comprising a control device, wherein the control device is configured to 3D print a refining portion on the refiner segment workpiece by using rebuilding production data of the refining portion.

According to a further aspect of the present invention, there is provided a program for causing a computer to execute the method according to above aspect of the present invention and the program is stored in a computer-readable non-transitory storage medium of the system.

According to still another aspect of the present invention, there is provided a rebuilt refiner segment for refining lignocellulosic material and the rebuilt refiner segment is produced by the method according to above aspect of the present invention.

Generally, in these preferred embodiments of the present disclosure, the refiner segment workpiece may be a refiner segment of which the refining surface is yet not a ready-to-use refining surface that achieves a satisfactory quality of the refined lignocellulosic material. The refiner segment workpiece may be a semifinished refiner segment, which is a refiner segment with its refining portion or refining surface has not been completely produced or has been produced to a certain extent of completeness. For example, the refiner segment workpiece is a portion of refiner segment which has a complete base portion obtained by molding/casting/3D printing process, and an incomplete refining portion which has no function of refining yet, and the incomplete refining portion can be completed by building refining portion on the complete base portion to form the refining surface. The refiner segment workpiece may be obtained from a used refiner segment, being a part of the used refiner segment. In this case, the used refiner segment is performed a machining process to obtain a desired final shape, e.g., traditional machining process, such as turning, boring, drilling, milling, grinding, abrasive cutting and the like, e.g., non-traditional machining process, such as ultrasonic machining, laser beam machining, water jet machining, abrasive water jet machining reaming and the like. The refiner segment workpiece may be obtained from a used refiner segment, being the whole of the used refiner segment. In this case, the used refiner segment is directly used as the refiner segment workpiece without performing machining process, merely cleaning or slightly polishing is performed to the used refiner segment. In other words, the refiner segment workpiece may be a used refiner segment that has been used in manufacturing mechanical pulp process for a certain period of time with some parts of its refining surface have been worn or chipped and no longer good to use as a refiner element. The refiner segment workpiece may be a used refiner segment that has been used until its life time is reached.

Accordingly, the used refiner segment, i.e., the old refiner segment or the expired refiner segment, is reused as a refiner segment workpiece to become a ready-to-use refiner segment, since only the refining portion needs to be produced on the existing base portion, and the refiner segment is produced in less time thus saving the costs and not wasting the useful parts of the used refiner segments.

Generally, in this preferred embodiment of the present disclosure, the rebuilding production data of the refining portion may be provided in any suitable data type. Usually, 3D printable models may be created with a computer-aided design (CAD) package, via a 3D scanner, or by a plain digital camera and photogrammetry software. 3D printed models created with CAD result in reduced errors and can be corrected before printing, allowing verification in the design of the object before it is printed. Accordingly, CAD data are preferred in the present disclosure.

Generally, in this preferred embodiment of the present disclosure, the 3D printing step may be performed by any suitable 3D printer type. Different 3D printing techniques can be employed, but a preferred technique is so-called direct metal laser sintering (DMLS), which utilizes an ytterbium (Yb) fiber laser fired into a bed of metal powder. The printing materials are selected from metals or metal alloys, plastics, polymers, wax, and plaster while metals or metal alloys form a most preferable material. The present invention should not be limited to a specific printing material. In the 3D printing process, a printing material which is the same material as the refiner segment workpiece may be used for 3D printing the refining portion. A printing material which is different but compatible with that of the refiner segment workpiece may also be used for 3D printing the refining portion. Preferred printing material of the refining portion may be selected from aluminum (Al), copper (Cu), chromium (Cr), zirconium (Zr), metal alloys such as bronze, metal alloys which comprise Cu, Cr and Zr, various kinds of steels such as Inconel steel, Maraging steel, and the like.

In one modification of the exemplary embodiment of the present disclosure, the rebuilding production data is obtained from original production data of the refiner segment or is new production data obtained from scanned data by scanning the refiner segment workpiece.

Generally, in this preferred embodiment of the present disclosure, regarding the rebuilding production data of the refining portion of the refiner segment workpiece, if the refiner segment workpiece is a used refiner segment with its own original production data, which is a complete production data for manufacturing process, e.g., a molding process, a casting process, a 3D printing process and the like, then its rebuilding production data may be obtained from said original production data, i.e., the data may be a portion of said original production data. In other words, in this situation, the refiner segment workpiece may be deemed as an almost-finished product, namely a refiner segment of which the most part of manufacturing process has been performed (e.g., 90% of the manufacturing process has been finished), and thus only the rest part of manufacturing process (e.g., 10% of the manufacturing process) which is the worn portion out of the whole refiner segment, is needed to be performed, to obtain a ready-to-use refiner segment. Here, the rebuilding production data may refer to said rest part of manufacturing process that is needed to be performed. Accordingly, the refiner segment is produced in less time thus saving the manufacturing time and costs.

If the refiner segment workpiece is a used refiner segment manufactured by other manufacturing company or its original production data is no longer available, a new production data may be obtained by performing a scanning process to the refiner segment workpiece. Then, the rebuilding production data of the refining portion of the refiner segment workpiece may be obtained from scanned data of the refiner segment workpiece and calculation (e.g., carrying out the whole production data of the refiner segment by using the scanned data and obtaining the rebuilding production data of the refining portion) so as to obtain the required rebuilding production data, i.e., the new production data. In other words, in this situation, the refiner segment workpiece may also be deemed as an almost-finished product, namely a refiner segment of which the most part of manufacturing process has been performed (e.g., 90% of the manufacturing process has been finished), and thus only the rest part of manufacturing process (e.g., 10% of the manufacturing process) which is the worn portion out of the whole refiner segment, is needed to be performed, to obtain a ready-to-use refiner segment. Here, the rebuilding production data may refer to said rest part of manufacturing process that is needed to be performed. Accordingly, even though the old production data of the used refiner segment is not available, it can be easily obtained scanning and calculation, thereby the refiner segment is produced in less time thus saving the manufacturing time and costs.

In one modification of the exemplary embodiment of the present disclosure, the step of 3D printing comprises determining a refining area of the refiner segment workpiece, and the refining area is where the refining portion is to be 3D printed. In other words, the step of determining the refining area of the refiner segment workpiece is to ensure that the control device knows the exact position of the worn refiner segment arranged on the stage, such that the rebuilding production data exactly conforms with the patterns of the refiner segment (the pattern of bars and dams) and the 3D printer starts 3D printing on the exact position of the pattern of a bar or dam.

Generally, in this preferred embodiment of the present disclosure, after the refiner segment workpiece is arranged on the stage and before the step of 3D printing the refining portion on the refiner segment workpiece, the refining area where the refining portion is to be 3D printed is determined. The refining area may be located on a portion of a top surface of the refiner segment workpiece, or may be the entire top surface of the refiner segment workpiece.

In one modification of the exemplary embodiment of the present disclosure, the original production data is a mathematically sliced data file comprising data of a pattern of the refiner segment which is mathematically sliced into layers, and an area of the refiner segment workpiece which corresponds to data of one sliced layer among the mathematically sliced layers is determined as the refining area of the refiner segment workpiece.

Generally, in this preferred embodiment of the present disclosure, the production data of the refiner segment, i.e., data for the 3D refiner segment model, is, for example, produced with a CAD (Computer-Aided Design) program package, where the 3D refiner segment model created by the CAD program is a mathematical representation stored in data file (mathematically sliced data file) with a suitable file format, e.g. a STL (STereo-Lithography) file. Suitable CAD program packages are, for example, Pro/Engineer and SolidWorks. The mathematically sliced data file, i.e., the original production data, of the refiner segment to which the refiner segment workpiece is corresponding, includes data of a plurality sliced layers, thus among the sliced layers there may exist data of one sliced layer to which an area of the refiner segment workpiece is corresponding, and said data of the one sliced layer of the refiner segment workpiece may be obtained by matching or mapping the scanned data with the stored original production data. Then, the area of the refiner segment workpiece which corresponds to said data of the one sliced layer is determined as the refining area. For example, after carrying out said data of the one sliced layer, the step of 3D printing the refining portion may start performing with said data of the one sliced layer.

Accordingly, if the refiner segment workpiece is an already used refiner segment that has been 3D printed some of the stored data, e.g., its mathematically sliced data file, then said mathematically sliced data file could be re-used for rebuilding the refining portion, which would be a very efficient process in producing refiner segments. Once the refining area is determined, the step of 3D printing the refining portion can be proceeded, thus the bars and dams which have been worn can be rebuilt and a refiner segment as good as new can be obtained. Thereby, the worn refiner segments are able to represent a substantial value and the expensive process of melting them down and casting them again can be avoided.

In one modification of the exemplary embodiment of the present disclosure, the step of determining the refining area of the refiner segment workpiece comprises: removing a worn portion of the refiner segment workpiece by a machining process until the area corresponding to the data of the one sliced layer among the mathematically sliced layers is obtained; and determining the obtained area as the refining area.

Generally, in this preferred embodiment of the present disclosure, before rebuilding the refining portion, the refiner segment workpiece may be subjected to a machining process to determine the refining area, i.e., the area corresponding to the data of the one sliced layer among the mathematically sliced layers. For example, if the refiner segment workpiece is an already used refiner segment that has been 3D printed some of the stored data, the refining area corresponding to said data of the one sliced layer may be determined after performing a machining process, for example, by performing a grinding process to the worn surface of the refiner segment workpiece to form a flat surface. In other words, the used refiner segment, i.e., the refiner segment workpiece, is cleaned and the worn surface is machined, e.g., to a flat condition, on which bars and dams are rebuilt by performing the step of 3D printing the refining portion on the machined flat surface.

In one modification of the exemplary embodiment of the present disclosure, the step of determining the refining area of the refiner segment workpiece comprises: scanning a worn portion of the refiner segment workpiece to obtain scanned data; and determining the refining area according to the scanned data.

Generally, in a preferred embodiment of the present disclosure, if the refiner segment workpiece is an already used refiner segment that has been 3D printed some of the stored data, the refining area corresponding to said data of the one sliced layer may be determined directly, that means without performing machining process, by scanning the worn surface of the refiner segment workpiece to obtain scanned data, and the scanned data is used to matching or mapping with the stored data to determine said data of the one sliced layer to which the refining area is corresponding.

Accordingly, the producing time and process of the refiner segment are significantly reduced and thus a refiner segment can be produced with improved and/or more efficient manufacturing processes.

### Effect

A method, system and a program for producing a refiner segment for refining lignocellulosic material, suitable for rebuilding a refiner segment out of a worn refiner segment, and a rebuilt refiner segment are provided, and the following technical effects can be achieved: making the worn refiner segments represent a substantial value; avoiding the expensive process of melting them down and casting the used refiner segments again; making the greatest advantages of existing data files of 3D printable models of the refiner segments; significantly increasing the variety of shapes and arrangements of surface structures (the pattern of bars and dams) of the refining portions such that new structures may be implemented and tested with moderate expenses.

### BRIEF DESCRIPTION OF THE DRAWINGS

FIG. 1 is a diagram showing a configuration example of a method for producing a refiner segment.

FIG. 2 schematically illustrates an example of a system for producing a refiner segment.

### DESCRIPTION OF THE EMBODIMENTS

Hereinafter, an embodiment of the present invention is described with reference to the drawings. In the following description, the same components are designated by the same reference signs, and the names and functions thereof are the same. Therefore, detailed description thereof is omitted.

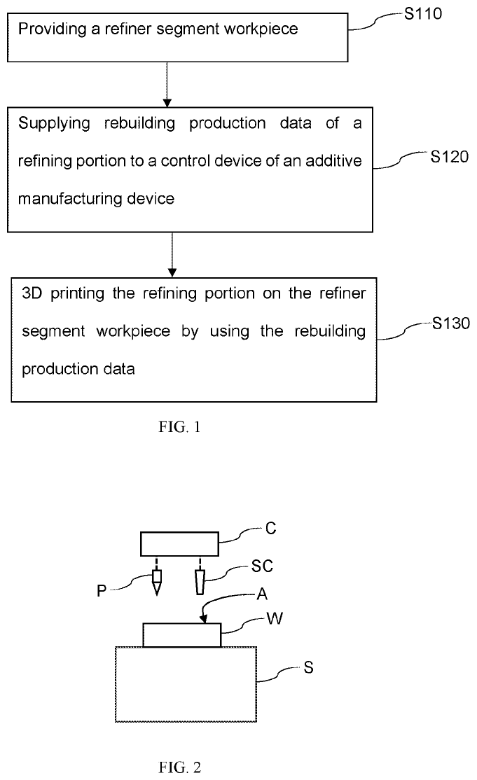

FIG. 1 is a diagram showing a configuration example of a method for producing a refiner segment. FIG. 2 schematically illustrates an example of a system for producing a refiner segment. The present invention is based on the use of an additive manufacturing device (a 3D printer (P)) to produce a refiner segment and a used refiner segment is used as a refiner segment workpiece (W). More specifically, according to the disclosure, a refiner segment can be produced following manufacturing steps.

In step S110, a refiner segment workpiece (W) is provided. The refiner segment workpiece (W) is arranged on the stage (S) to be performed the step of 3D printing. In Step S120, the rebuilding production data of the refining portion is supplied to the control device (C) of the additive manufacturing device. In step S130, the 3D printer (P) performs 3D printing the refining portion on the refiner segment workpiece (W) by using the rebuilding production data. As such, a rebuilt refiner segment for refining lignocellulosic material is produced.

In one specific embodiment of the present disclosure, the production data of the refiner segment, i.e., data for the 3D refiner segment model, which is produced with a CAD (Computer-Aided Design) program package, where the 3D refiner segment model created by the CAD program is a mathematical representation stored in data file with a STL file, is stored in the computer. The production data of the refiner segment includes the rebuilding production data of the refining portion, namely, the rebuilding production data is a portion of the data for the 3D refiner segment model (the mathematically sliced data file). Optionally but preferably, the data file is checked for errors and imperfections with a suitable software program package, e.g. a program package provided by the company EOS e-manufacturing solutions. Besides correcting errors in the data file, the mathematically sliced data files of the refiner segments are ensured to include data corresponds to all geometrical structures in the refiner segment models and are reproducible in subsequent manufacturing steps and are suitable for such manufacturing steps. Depending on the geometrical structures incorporated in the refiner segments and on the specific 3D printer and 3D printer software chosen, the data contained in the data file are mathematically sliced into layers and the thickness of each layer may be from 0.01 mm to 0.1 mm, and preferably from 0.025 mm to 0.06 mm. Then, the corresponding data of the rebuilding production data, which is a portion of the mathematically sliced data file, are then input into the control device (C) of the 3D printer (P), and the refining portion is 3D printed, the refining portion is rebuilt on the refiner segment workpiece (W) arranged on the stage (S), and a refiner segment as good as new is obtained. Different 3D printing techniques can be employed, but a preferred technique is so-called direct metal laser sintering (DMLS), which utilizes an ytterbium (Yb) fiber laser fired into a bed of metal powder.

In one specific embodiment of the present disclosure, the refiner segment workpiece (W) is arranged on the stage (S), a scanning process, by using a scanning device (SC) controlled by the control device (C), is performed to the refiner segment workpiece (W) to obtain a scanned data. The scanned data at least includes data corresponding to the refining area (A), i.e., the area where the refining portion is to be 3D printed, of the refiner segment workpiece (W). Said data corresponding to the refining area (A) may be obtained by CAD package via a 3D scanner or a plain digital camera and photogrammetry software. The rebuilding production data of the refining portion is obtained by calculation (such as data matching, data mapping or the like) according to said data corresponding to the refining area (A) and the original production data of the refiner segment, in a case that the refiner segment workpiece is originally obtained from a used refiner segment with its own original production data. Then, the refining area (A) of the refiner segment workpiece (W) is determined, and the later 3D printing process may be proceeded by starting the step of 3D printing the refining portion from the refining area (A), to obtain a refiner segment as good as new. In other words, when the scanned data is matched with said data corresponding to the refining area (A), then the area of the scanned data is determined as the refining area (A) of the refiner segment workpiece (W). Accordingly, by the step of determining the refining area (A) of the refiner segment workpiece (W), it is ensured that the control device knows the exact position of the refiner segment workpiece (W) arranged on the stage (S), such that the rebuilding production data exactly conforms with the patterns of the refiner segment (the pattern of bars and dams) and the 3D printer (P) starts 3D printing on the exact position of the pattern of a bar or dam.

In one specific embodiment of the present disclosure, in a case that the refiner segment workpiece is not obtained from a used refiner segment with its own original production data or the original production data is no longer available, a scanning process may also be performed to the refiner segment workpiece (W) to obtain a scanned data (e.g. 3D surface data), which at least includes data corresponding to the refining area (A). In the context of the present disclosure, scanning may refer to a variety of technologies for digitally acquiring the shape of a 3D object. The scanning may utilize sensor types including optical, acoustic, laser scanning, radar, thermal, and seismic in both contact and non-contact manner and active or passive techniques. For example, said data corresponding to the refining area (A) may be obtained by CAD package via a 3D scanner or a plain digital camera and photogrammetry software. Then, the rebuilding production data of the refining portion is obtained by calculation (such as slicing the scanned data to mathematically sliced layers, data matching, data mapping or the like) according to said data corresponding to the refining area (A), so as to obtain a new production data of the refiner segment. Then, after the refining area (A) of the refiner segment workpiece (W) is determined, the later 3D printing process may be proceeded by starting the step of 3D printing the refining portion from the refining area (A), to obtain a refiner segment as good as new.

Since the method of the invention can be employed to obtain a new refiner segment as good as new, the obtained product can then be used in creating a mold for producing refiner segments, and thus refiner segments can be produced by molding process in a traditional way.

In one specific embodiment of the present disclosure, before performing the step of 3D printing the refining portion on the refiner segment workpiece (W), a machining process is performed to the worn portion of the refiner segment workpiece (W). The worn portion of the refiner segment workpiece (W) may be removed by performing a machining process on the surface of the worn portion. For example, the worn portion of the refiner segment workpiece (W) is performed a grinding process to obtain a machined surface (for example a flat surface), so that the top surface of the worn portion is in a flat condition, herein the machined top surface of the worn portion is determined as the refining area (A). Herein, the obtained flat surface of the worn portion is used as a starting point for the 3D printing, onto which the printing material as a homogenous and equally thick layers are sequentially applied, so that the 3D printing quality and the connection quality between the worn portion and the new built portion is ensured. The top surface is performed a scanning process to obtain a scanned data. Similarly, the scanned data is used to obtain the rebuilding production data of the refining portion by calculation (such as data matching, data mapping or the like), so as to obtain the rebuilding production data of the refining portion. The machining process of the worn portion of the refiner segment workpiece may be performed until the area corresponding to the data of the one sliced layer among the mathematically sliced layers, i.e., the data corresponding to the refining area (A), is obtained. For example, the worn portion is machined and then scanned, machining and scanning process may be repeatedly perform, until the refining area (A) is determined. In addition, an optional scanning step may be performed before the machining step to determine the amount of to be removed material, e.g. by determining the duration of machining. Then, the later 3D printing process may be proceeded by starting the step of 3D printing the refining portion from the refining area (A), to obtain a refiner segment as good as new.

In one specific embodiment of the present disclosure, in the step of 3D printing the refining portion, the printing material can be selected from the same material as the material of the refiner segment workpiece.

In one specific embodiment of the present disclosure, in the step of 3D printing the refining portion, the printing material can be selected from a material that is different but compatible with the material of the refiner segment workpiece. Accordingly, the refining portion can be rebuilt with different material to achieve different material properties. Exemplary materials for printing may be selected from metals or metal alloys, plastics, polymers, wax, and plaster. Preferred printing material may be selected from aluminum (Al), copper (Cu), chromium (Cr), zirconium (Zr), metal alloys such as bronze, metal alloys which comprise Cu, Cr and Zr, various kinds of steels such as Inconel steel, Maraging steel, and the like.

In one specific embodiment of the present disclosure, a marking process such as making one or more alignment marks on the refiner segment workpiece may be performed before it is scanned by the scanning device (SC), so as to facilitate determining the refining area (A) while carrying out the rebuilding production data of the refining portion.

The embodiments disclosed here should be considered illustrative in all respects and not restrictive. The scope of the present invention is indicated by the appended claims rather than by the foregoing description, and all changes which come within the meaning and range equivalent to that of the claims are intended to be included herein.

### REFERENCE SIGNS LIST

A: refining area
C: control device
P: 3D printer
SC: scanning device
S: stage
S110, S120, S130: steps of the method

What is claimed is:

1. A method for producing a refiner segment for refining lignocellulosic material, wherein the method is suitable for rebuilding a refiner segment out of a worn refiner segment, the method comprising:
providing a refiner segment workpiece;
supplying rebuilding production data of a refining portion to a control device of an additive manufacturing device; and
3D printing the refining portion on the refiner segment workpiece by using the rebuilding production data.

2. The method according to claim 1, further comprising a step of obtaining the rebuilding production data,
wherein the rebuilding production data is obtained from original production data of the worn refiner segment or the rebuilding production data is new production data obtained from scanned data of the refiner segment workpiece.

3. The method according to claim 2, wherein
in a case of obtaining the rebuilding production data from the original production data of the worn refiner segment, the rebuilding production data is obtained based on a compensation value and the original production data, the compensation value is calculated by using the original production data, the compensation value is associated with a tolerance which is preliminarily set in the original production data when the original production data is established as a production data of a refiner segment model, and the refiner segment model is to be used to produce a refiner segment mold.

4. The method according to claim 2, wherein
in a case of obtaining the rebuilding production data as the new production data from the scanned data, the new production data is obtained by scanning the refiner segment workpiece.

5. The method according to claim 1, wherein the step of 3D printing comprises determining a refining area of the refiner segment workpiece, and the refining area is where the refining portion is started to be 3D printed.

6. The method according to claim 2, wherein the original production data is a mathematically sliced data file comprising data of a pattern of the refiner segment model which is mathematically sliced into layers, and an area of the refiner segment workpiece which corresponds to data of one sliced layer among the mathematically sliced layers is determined as the refining area of the refiner segment workpiece.

7. The method according to claim 6, wherein the step of determining the refining area of the refiner segment workpiece comprises:
removing a worn portion of the refiner segment workpiece by a machining process;
after the worn portion is removed, performing scanning and data matching process, wherein the machining process and the scanning and data matching process are repeatedly performed until the area corresponding to the data of the one sliced layer among the mathematically sliced layers is obtained; and
determining the obtained area as the refining area.

8. The method according to claim 7, wherein the step of determining the refining area of the refiner segment workpiece comprises:
performing the scanning and data matching process to the refiner segment workpiece without performing the machining process to the worn portion of the refiner segment workpiece to obtain scanned data; and
determining the scanned area as the refining area in a case that the area corresponding to the data of the one sliced layer among the mathematically sliced layers is obtained according to the scanned data.

9. A system for producing a refiner segment for refining lignocellulosic material, wherein the system is suitable for rebuilding a refiner segment out of a worn refiner segment, the system comprising:
a control device (C);
a stage (S), configured that a refiner segment workpiece (W) is adapted to be arranged thereon; and
an additive manufacturing device (P), configured to perform 3D printing and controlled by the control device (C), wherein the control device is configured to 3D print a refining portion on the refiner segment workpiece by using rebuilding production data of the refining portion.

10. The system according to claim 9, wherein the rebuilding production data is obtained from original production data of the worn refiner segment or the rebuilding production is new production data obtained from scanned data of the refiner segment workpiece.

11. The system according to claim 10, wherein
in a case of obtaining the rebuilding production data from the original production data of the worn refiner segment, the rebuilding production data is obtained based on a compensation value and the original production data, the compensation value is calculated by using the original production data, the compensation value is associated with a tolerance which is preliminarily set in the original production data when the original production data is established as a production data of a refiner segment model, and the refiner segment model is to be used to produce a refiner segment mold.

12. The system according to claim 10, wherein
in a case of obtaining the rebuilding production data as the new production data from the scanned data, the new production data is obtained by scanning the refiner segment workpiece.

13. The system according to claim 9, wherein the control device is configured to determine a refining area (A) of the refiner segment workpiece (W), and the refining area is where the refining portion is started to be 3D printed.

14. The system according to claim 10, wherein the system is configured that the original production data is a mathematically sliced data file comprising data of a pattern of the refiner segment model which is mathematically sliced into layers, and an area of the refiner segment workpiece which corresponds to data of one sliced layer among the mathematically sliced layers is determined as the refining area (A) of the refiner segment workpiece.

15. The system according to claim 14, further comprising:
a machining device, configured to remove a worn portion of the refiner segment workpiece (W) by a machining process; and
a scanning scanning device (SC), configured to perform scanning the refiner segment workpiece to obtain scanned data after the worn portion is removed;
wherein the control device is configured to perform data matching by using the scanned data after the worn portion is removed, the machining process and the scanning and data matching are repeatedly performed until the area corresponding to the data of the one sliced layer among the mathematically sliced layers is obtained, and the control device is configured to determine the obtained area as the refining area (A).

16. A program for causing a computer to execute the method according to claim 1, wherein the program is stored in a computer-readable non-transitory storage medium.

17. A refiner segment for refining lignocellulosic material, wherein the refiner segment is produced by the method according to claim 1.
